(19) United States
(12) Patent Application Publication
(10) Pub. No.: US 2020/0380474 A1
(43) Pub. Date: Dec. 3, 2020

(54) Monitoring Device and Monitoring System

(71) Applicant: Hitachi Industrial Equipment Systems Co., Ltd., Tokyo (JP)

(72) Inventors: Masashi KONO, Tokyo (JP); Nobuhiro TOTTORI, Tokyo (JP); Yuusuke NAKAGAWA, Tokyo (JP)

(21) Appl. No.: 16/880,850

(22) Filed: May 21, 2020

(30) Foreign Application Priority Data
May 31, 2019 (JP) 2019-102003

(51) Int. Cl. G06Q 10/00; H04L 29/08; G06Q 10/08; G05B 23/02; G06F 16/11

(52) U.S. Cl. CPC G06Q 10/20; H04L 67/125; G06Q 30/016; G05B 23/0218; G06F 16/116; G06Q 10/087

(57) ABSTRACT

A monitoring device includes: a base information acquisition unit that acquires information on operation and fault of an equipment arranged at a base and position information relating to the equipment; a natural environment information acquisition unit that acquires natural environment information in a region; and an analysis unit that specifies a position of the equipment in which the fault has occurred from the information acquired by the base information acquisition unit, associates the position with a region of the natural environment information, and associates the equipment in which the fault has occurred with the natural environment information.

### BACKGROUND OF THE INVENTION

### 1. Field of the Invention

The present invention relates to a monitoring device and a monitoring system that monitor operation states of a plurality of equipments as monitoring targets.

### 2. Description of the Related Art

Equipment maintenance has shifted from time-based maintenance in which maintenance is performed periodically to state-based maintenance in which maintenance is performed in accordance with a state of each equipment. In order to perform the state-based maintenance, it is necessary to constantly monitor the state, and a remote monitoring service using an IoT cloud has been spreading.

JP 2014-15746 A is known as a technique relating to a monitoring device that monitors a fault of an equipment. JP 2014-15746 A discloses that “detected values of a plurality of variables depending on operating conditions are input to an input device from a shovel. A processing device processes detected values of the plurality of variables input from the input device. The processing device uses a set of the detected values of the plurality of variables as one sample, extracts some samples having similar operating conditions on the basis of the detected values of the variables from a plurality of samples input from the input device, and uses the extracted samples as a standard sample group. Furthermore, target samples are evaluated on the basis of the standard sample group.”

JP 2014-15746 A discloses a technique for providing a shovel management device that can increase a detection accuracy of occurrence of abnormality. However, a relationship between the position of the shovel and the abnormality is not considered.

In some cases, a fault of an industrial equipment arranged at a plurality of service bases depends on the natural environment at the position of each service base, and thus, it is required to analyze a relationship between the natural environment and the fault at the position where the industrial equipment is arranged and to perform maintenance on the basis of the analysis result.

### SUMMARY OF THE INVENTION

The invention is to provide a monitoring device and a monitoring system for analyzing a relationship between a fault of an equipment and a natural environment for state-based maintenance in which maintenance is performed in accordance with a state of each equipment.

According to a preferred example of the invention, there is provided a monitoring device, including: a base information acquisition unit that acquires information relating to an equipment arranged at a base, information relating to fault, and position information of the equipment; a natural environment information acquisition unit that acquires natural environment information; and an analysis unit that specifies a position of the equipment in which the fault has occurred from the information acquired by the base information acquisition unit, associates the position with a region of the natural environment information, and associates the equipment in which the fault has occurred with the natural environment information.

According to another preferred example of the invention, there is provided a monitoring system, including: a first equipment provided at a first base; a second equipment provided at a second base; the aforementioned monitoring device that is connected to the first equipment and the second equipment via a network; and an external device that has an acquisition unit that acquires climate information and region information from an external system and a providing unit that provides the climate information and the region information to the monitoring device.

According to this invention, it is possible to analyze a relationship between a fault of an equipment and a natural environment for state-based maintenance in which maintenance is performed in accordance with a state of each equipment.

### BRIEF DESCRIPTION OF THE DRAWINGS

FIG. 1 is a configuration diagram illustrating a monitoring system according to a first embodiment;

FIG. 2 is a diagram illustrating functional blocks of a management server;

FIG. 3 is a diagram illustrating functional blocks of an external server;

FIGS. 4A to 4F are diagrams illustrating databases;

FIG. 5 is a diagram illustrating a processing flow of a registration program;

FIG. 6 is a diagram illustrating a processing flow of an analysis program;

FIG. 7 is a diagram illustrating a processing flow of a visualization program;

FIG. 8 is a diagram illustrating a processing flow of a reception program of the external server;

FIG. 9 is a diagram illustrating a processing flow of a transmission program of the external server;

FIG. 10 is a configuration diagram illustrating a monitoring system according to a second embodiment;

FIG. 11 is a diagram illustrating functional blocks of a data collection server;

FIG. 12 is a diagram illustrating a processing flow of a reception program of the data collection server; and

FIG. 13 is a diagram illustrating a processing flow of a transmission program of the data collection server.

### DETAILED DESCRIPTION OF THE PREFERRED EMBODIMENTS

Embodiments will be described below with reference to the drawings.

### First Embodiment

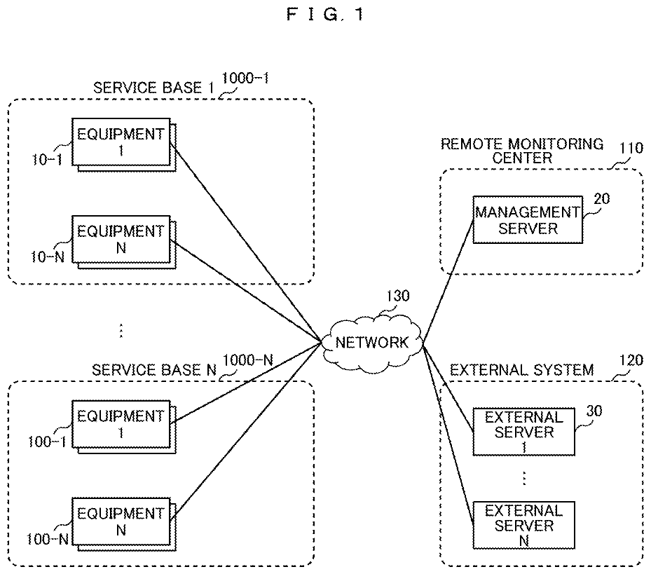

FIG. 1 is a diagram illustrating an example of a configuration of a monitoring system according to a first embodiment. The monitoring system according to the first embodiment includes a plurality of service bases such as a service base 1 1000-1 and a service base N 1000-N as locations that provide services, a remote monitoring center 110 that monitors the plurality of service bases, and an external system 120 such as an external Web site.

The plurality of service bases such as the service base 1 1000-1, the remote monitoring center 110, and the external system 120 are connected via a network 130.

Each service base such as the service base 1 1000-1 as a location that provides a service has an equipment such as an equipment 1 10-1.

The remote monitoring center 110 has a management server 20 that manages equipment registration information, equipment operation state information and manages information acquired from an external system.

The external system 120 has an external server 30 that manages external weather information, climate information, region information, and the like.

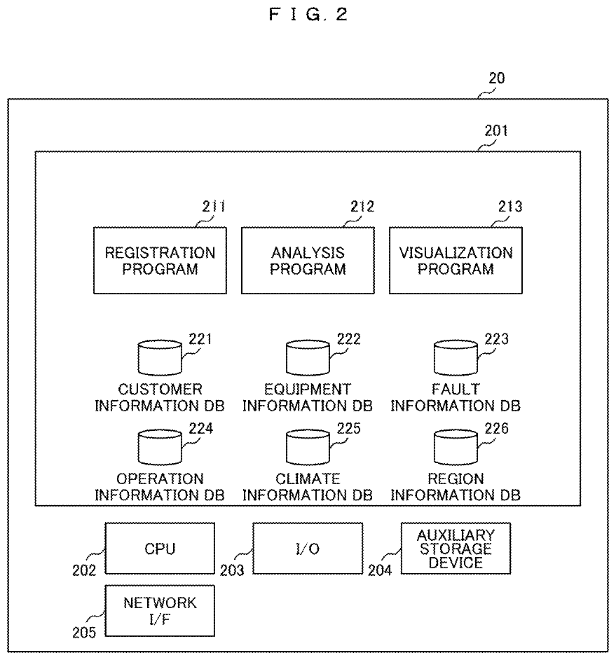

FIG. 2 is a diagram illustrating an example of a configuration of the management server 20. The processing content of the management server 20 is stored (recorded) in a form of a program (software) in an auxiliary storage device 204 of a general computer, and a central processing unit (CPU) 202 deploys a program read from the auxiliary storage device 204 on a memory 201 and executes the program. The management server 20 communicates with other servers and equipments via a network I/F 205.

An input/output interface (I/O) 203 is a user interface through which a user inputs an instruction to the management server 20 and an execution result of the program and the like are presented to the user. Input/output devices (for example, a keyboard, a mouse, a touch panel, a display, and a printer) are connected to the I/O 203. A user interface provided by a management terminal connected via a network may be connected to the I/O 203.

The CPU 202 is a processor that executes programs stored in the memory 201. The memory 201 includes a read only memory (ROM) which is a nonvolatile storage element and a random access memory (RAM) which is a volatile storage element.

The ROM stores an immutable program (for example, Basic Input Output System (BIOS)). The RAM is a high-speed, volatile storage element such as a dynamic random access memory (DRAM) and temporarily stores programs stored in the auxiliary storage device 204 and data used when the programs are executed.

The memory 201 stores a registration program 211, an analysis program 212, and a visualization program 213.

In addition, the memory 201 stores a customer information database (DB) 221, an equipment information DB 222, a fault information DB 223, an operation information DB 224, a climate information DB 225, and a region information DB 226.

The auxiliary storage device 204 is a large-capacity, non-volatile storage device such as a magnetic storage device (Hard Disk Drive (HDD)) and a flash memory (Solid State Drive (SSD)). In addition, the auxiliary storage device 204 stores the programs executed by the CPU 202 and data used when the programs are executed. That is, the programs are read from the auxiliary storage device 204, loaded into the memory 201, and executed by the CPU 202.

The management server 20 is a computer system configured on one physical computer or on a plurality of logical or physical computers, and the programs stored in the memory 201 may operate in separate threads on the same computer or may operate on a virtual computer constructed on a plurality of physical computer resources. In addition, the management server 20 and other devices may be accommodated in one physical or logical computer. In addition, all or some of the processes realized by executing the programs may be realized by hardware (for example, a field-programmable gate array).

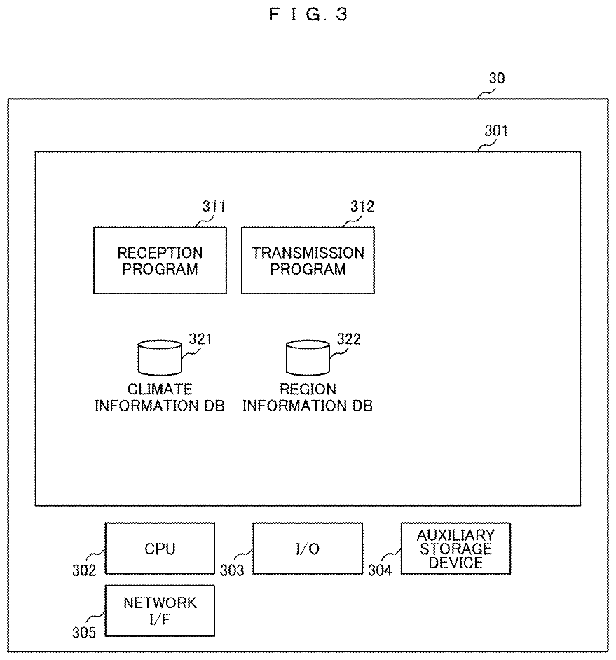

FIG. 3 is a diagram illustrating an example of a configuration of the external server 30. The description of the same content as those of the server in FIG. 2 will be omitted.

The memory 301 stores a reception program 311 and a transmission program 312.

The memory 301 stores a climate information DB 321 and a region information DB 322.

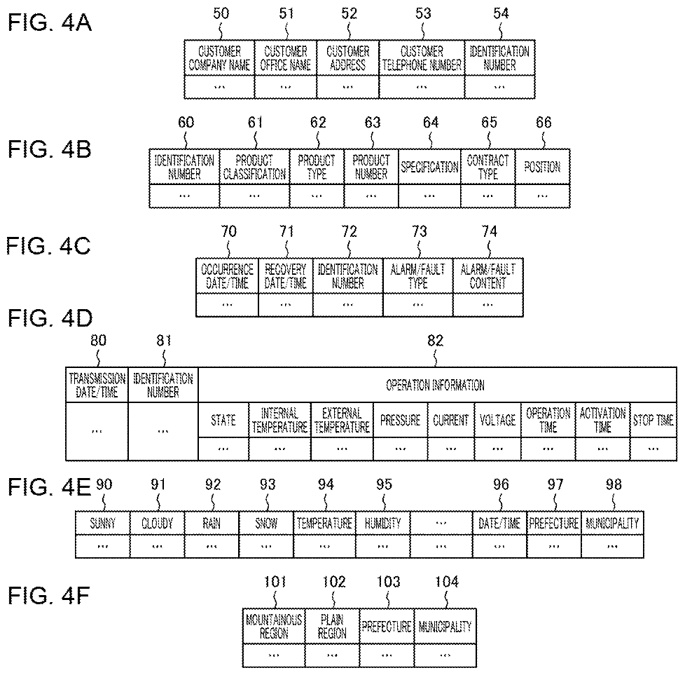

FIG. 4 is a diagram illustrating databases recorded in the memory 201 of the management server 20 and the memory 301 of the external server 30. FIG. 4A illustrates the customer information DB 221. The customer information DB 221 is a database that records a customer company name 50, a customer office name 51, a customer address 52, a customer telephone number 53, and an identification number 54.

FIG. 4B illustrates the equipment information DB 222. The equipment information DB 222 is a database that records an identification number 60, a product classification 61, a product type 62, a product number 63, a specification 64, a contract type 65, and a position 66.

FIG. 4C illustrates the fault information DB 223. The fault information DB 223 is a database that records an occurrence date/time 70, a recovery date/time 71, an identification number 72, an alarm/fault type 73, and an alarm/fault content 74.

FIG. 4D illustrates the operation information DB 224. The operation information DB 224 is a database that records a transmission date/time 80, an identification number 81, and operation information 82. The operation information 82 includes a state, an internal temperature, an external temperature, a pressure, a current, a voltage, an operation time, an activation time, and a stop time.

FIG. 4E illustrates the climate information DB 225. The climate information DB 225 is a database that records sunny 90, cloudy 91, rain 92, snow 93, temperature 94, humidity 95, and the like, a date/time 96, a prefecture 97, and a municipality 98.

FIG. 4F illustrates the region information DB 226. The region information DB 226 is a database that records a mountainous region 101, a plain region 102, a prefecture 103, and a municipality 104.

The information in the embodiment will be described with reference to a database. However, the information may not be necessarily be represented by a data structure of a database, but the information may be represented by a data structure of a list, a table, or the like. Therefore, the “table”, the “list”, the “DB”, and the like may be simply referred to as “information”.

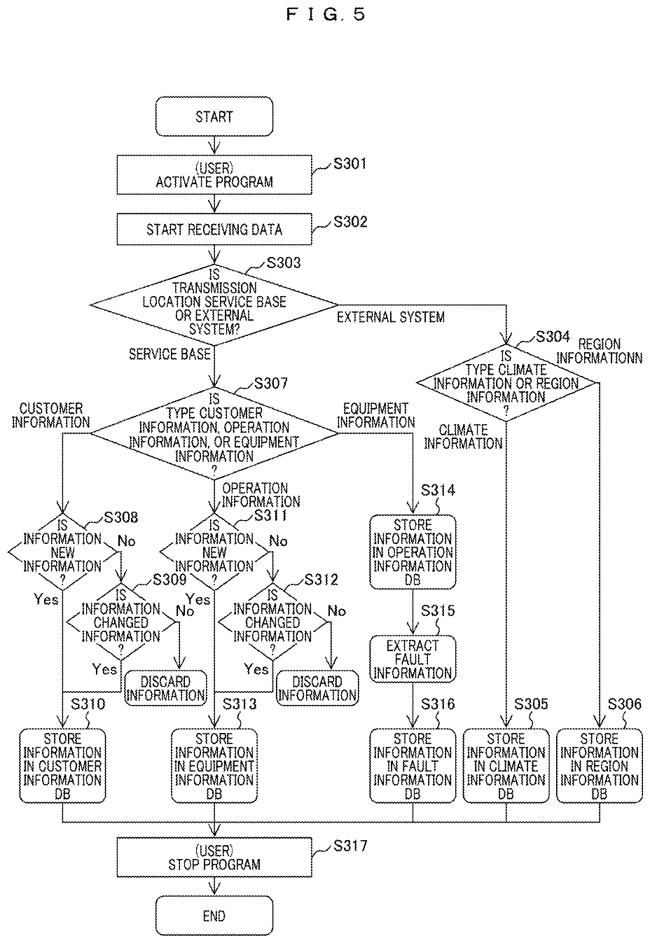

FIG. 5 is a diagram illustrating a processing flow of the registration program 211 in the management server 20.

The user activates the registration program by using an input/output device or the like (S301).

The CPU of the management server 20 starts receiving data from an outside of the management server 20 via the network (S302).

It is determined whether the transmission location is the service base or the external system 120 (S303).

In the description of FIG. 5, a processing unit that stores information from a service base in a DB is called a base information acquisition unit, and a processing unit that stores information from an external system in a DB is called a natural environment information acquisition unit.

In a case where the location (for example, the transmission location) where the data has been acquired is a service base, it is determined whether the type of the acquired information is customer information, equipment information, or operation information (S307).

In a case where the acquired data relates to customer information, it is determined whether the customer information is new customer information (S308). In a case where the customer information is new customer information, the customer information is stored in the customer information DB (S310).

In a case where the acquired customer information is not new customer information, it is determined whether the information is information that is to change the information recorded in the customer information DB (S309).

In a case where the information is information that is to change the customer information, the customer information DB is updated (S310). In a case where the customer information is information that is not to change, the information is discarded (No in S309).

In a case where the acquired data relates to equipment information, it is determined whether the acquired data is new equipment information (S311).

In a case where the data is new equipment information, the information is stored in the equipment information DB (S313).

In a case where the equipment information is not new equipment information, it is determined whether the information is information that is to change the content of the equipment information DB (S312).

In a case where the information is the equipment information that is to change, the information is stored in the equipment information DB (S313).

In a case where the information is the equipment information that is not to change, the information is discarded (No in S312).

In a case where the acquired data relates to operation information, the information is stored in the operation information DB (S314). Then, the fault information is extracted from the operation information (S315). The extracted fault information is stored in the fault information DB (S316).

In a case where the transmission location is an external system, it is determined whether the acquired information is climate information or region information (S304).

In the case of the climate information, the information is stored in the climate information DB (S305). In the case of the region information, the information is stored in the region information DB (S306).

After any one or a plurality of steps of S310, S313, S316, S305, and S306 are executed, the registration program ends upon receiving a user instruction (S317).

In the registration program 211, each process of from S302 to S316 may be repeated at a certain period each time operation data is received from the equipment 10-1 or the like. In a case where an event such as the fault or the alarm has occurred, the process may be repeated so as to receive the operation data and the fault data.

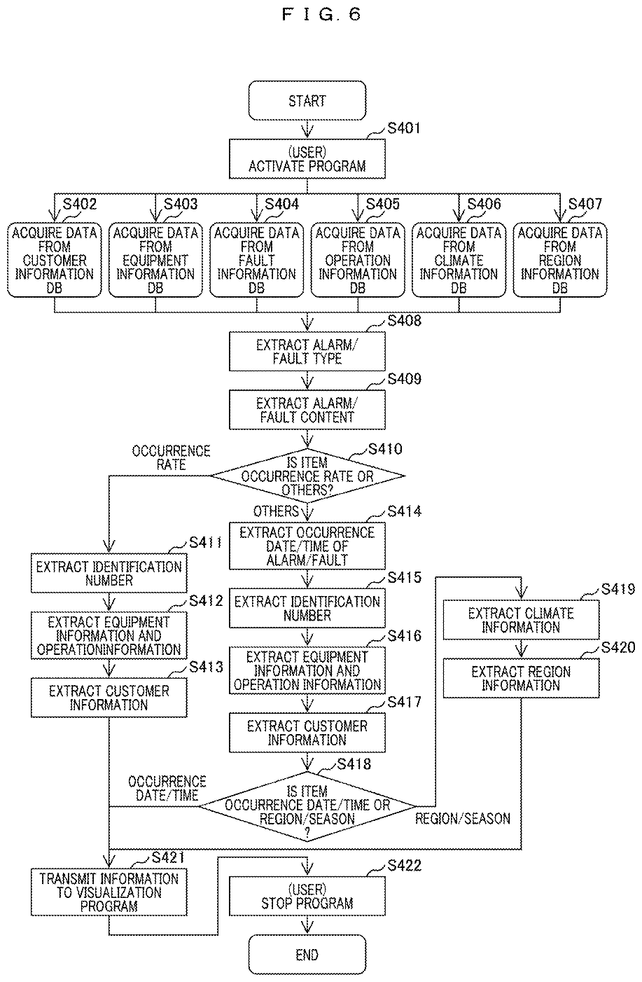

FIG. 6 is a diagram illustrating a processing flow of the analysis program 212 in the management server 20.

The analysis program is activated by an instruction of the input/output device from the user (S401).

Data is acquired from the customer information DB 221 (S402), and data is acquired from the equipment information DB 222 (S403). Data is acquired from the fault information DB 223 (S404). Data is acquired from the operation information DB 224 (S405). Data is acquired from the climate information DB 225 (S406). Data is acquired from the region information DB 226 (S407). The processes from S402 to S407 are executed in parallel or sequentially.

Among the acquired data, the alarm/fault type 73 is extracted from the fault information DB 223 (S408). Both the fault and the alarm indicate abnormal states different from normal states and are distinguished in advance on the basis of the operation state.

Then, the alarm/fault content 74 is extracted from the fault information DB 223 (S409).

Next, it is determined whether the instruction from the user by using the input/output device or the like is an alarm/fault occurrence rate or other items (S410). Herein, the instruction from the user includes a designation for specifying an equipment to be monitored, for example, a compressor.

In a case where the item instruction is the “occurrence rate”, an identification number corresponding to the specified compressor is extracted (S411).

The equipment information and operation information corresponding to the identification number extracted in S411 are extracted (S412).

The customer information corresponding to the identification number extracted in S411 is extracted (S413).

Then, the extracted equipment information and the extracted customer information are transmitted to the visualization program (S421).

In a case where the item instruction is “others”, the alarm/fault occurrence date/time acquired from the fault information DB is extracted (S414).

The identification number at which the alarm/fault has occurred is extracted from the fault information in which the extracted alarm/fault has occurred in S414 (S415).

The equipment information and the operation information corresponding to the identification number acquired in S415 are extracted (S416).

The customer information corresponding to the identification number acquired in S415 is extracted (S417).

Then, it is determined whether the item instructed from the user is “occurrence date/time” or “region/season” (S418).

In a case where the item instruction of “occurrence date/time” is received, the equipment information of the equipment in which the fault or alarm has occurred at the “occurrence date/time”, the alarm/fault type, the alarm/fault content, the operation information, and the customer information are transmitted to the visualization program (S421).

In addition, in a case where the item instructed by the user is a relationship between the “region/season” and the alarm/fault, the weather information of the region where the equipment where the fault or the alarm has occurred is arranged at the date/time when the fault or the alarm has occurred is extracted (S419).

Specifically, a position of the equipment in which the fault or the alarm has occurred is specified from a customer address 52 of the customer information extracted in S417 or a position 66 in the equipment information extracted in S416. The specified position, the date/time when the fault or the alarm has occurred, the date/time 96 of the climate information, and the information of the prefecture 97 and the municipality 98 are associated with each other to narrow down the related records, and the narrowed natural environment records of the temperature 94 and the humidity 95 of the climate information and the like are extracted.

Then, information on the region where the equipment in which the fault or the alarm has occurred is arranged is extracted (S420). Specifically, the region information corresponding to the information of the prefecture 97 or the municipality 98 specified in S419 is specified, and the information of the specified region (such as a mountainous region 101) is extracted.

The extracted equipment information, operation information, customer information, climate information, and region information are transmitted to the visualization program (S421).

Then, upon receiving the instruction of the analysis program from the user, the process of the analysis program ends (S422).

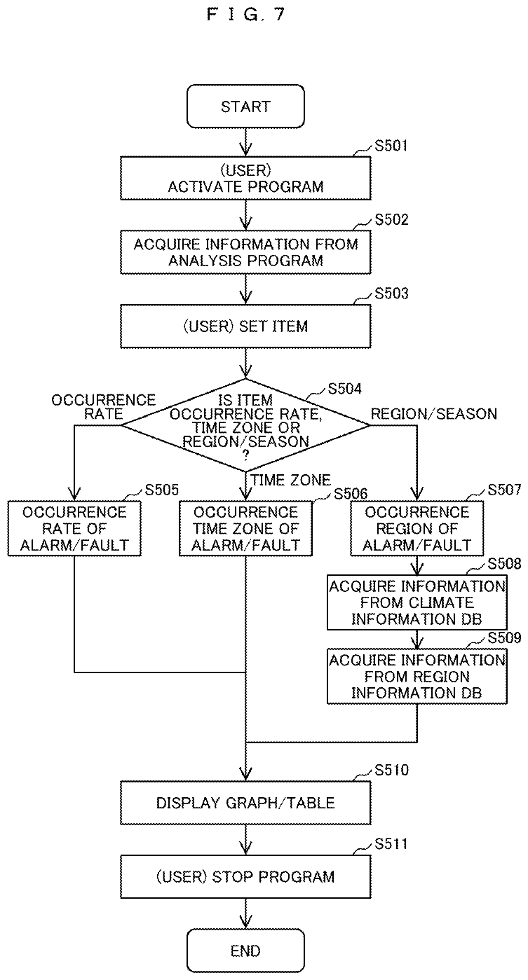

FIG. 7 is a diagram illustrating a processing flow of the visualization program 213 in the management server 20.

The visualization program 213 is activated on the basis of an instruction from the user via the input/output device (S501).

The information of the program recorded in the memory 201 or the like transmitted from the analysis program 212 is acquired (S502).

An instruction of an item such as an occurrence rate of the alarm/fault, time zone of the alarm/fault, or a region/season of the alarm/fault is received from the user (S504). Herein, an instruction of the compressor to be analyzed may be received.

In a case where the item is the alarm/fault occurrence rate, the process relating to the alarm/fault occurrence rate is executed from the alarm/fault type, the alarm/fault content, the equipment information, and the customer information transmitted from the analysis program 212 (S505).

In a case where the item is the occurrence time zone of the alarm/fault, the process relating to the occurrence time zone of the alarm/fault is executed from the occurrence date/time of the alarm/fault, the alarm/fault type, the alarm/fault content, the equipment information, and the customer information transmitted from the analysis program 212 (S506).

In a case where the item is the region/season of the alarm/fault, the process relating to the region of the equipment where the alarm/fault has occurred is executed from the climate information and the region information corresponding to the alarm/fault, the occurrence date/time of the alarm/fault, the alarm/fault type, the alarm/fault content, the equipment information, and the customer information transmitted from the analysis program 212 (S507).

In a case where the indication of the season is summer, the identification number of the failed equipment is specified in a case where the occurrence date/time of the alarm/fault is summer, and the position of the specified equipment is specified from the customer information or the equipment information. Then, it is possible to extract the climate information and the region information on the specified position and to narrow down related information as to under what kind of natural environment the equipment in which the fault has occurred in summer has failed.

In a case where an instruction to visualize information other than the information extracted by the analysis program 212 is received in the item instruction in S504, information is extracted from the climate information DB relating to the alarm/fault according to the instruction content (S508), and information is extracted from the region information DB relating to the alarm/fault (S509). For example, in S418, the relationship with the season such as summer is designated on the basis of the fault occurrence date/time. However, in some cases, in S504, the temperature range may be indicated to visualize the equipment in which the alarm/fault has occurred. In this case, the equipment in which the alarm/fault has occurred and the temperature information of the region corresponding to the equipment are extracted from the information transmitted from the analysis program 212, and in a case where a value of the temperature is included in the designated temperature range, it is visualized that there is a possibility that the temperature and the fault of the equipment relate to each other.

A graph or a table is displayed on the basis of the information acquired in S505, S506, and S509 (S510). For example, it is possible to display on a map a distribution of failed compressors located in a region where the temperature is equal to or higher than the temperature designated by the user.

Upon receiving an instruction from the user, the visualization program is stopped (S511).

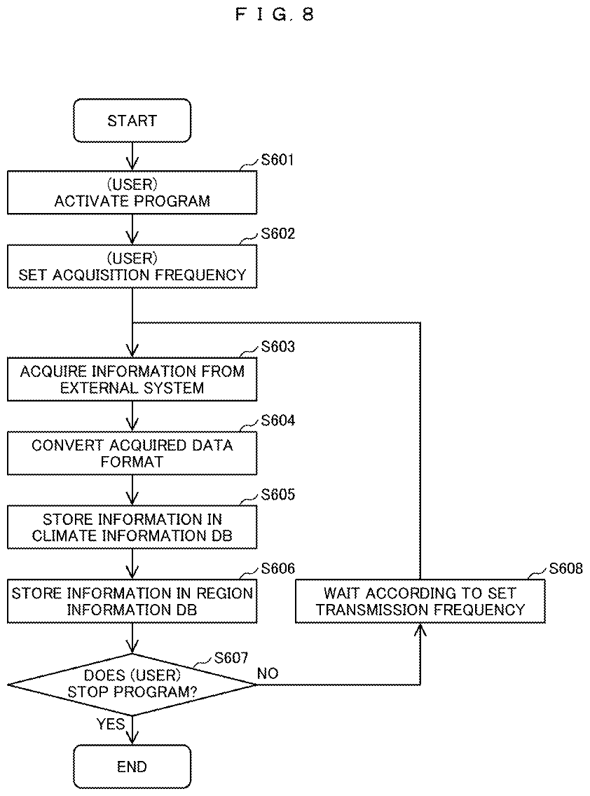

FIG. 8 is a diagram illustrating a processing flow of the reception program 311 in the external server 30.

The reception program 311 is activated on the basis of an instruction from the user via the input/output device (S601).

On the basis of an instruction from the user, setting of the acquisition frequency of the climate information and the region information from the external system is received (S602).

Information is acquired from the external system via the network 130 (S603). The information acquired from the external system is converted into a format in the external server 30 (S604).

Among the information converted in S604, information relating to the climate information is stored in the climate information DB (S605).

Among the information converted in S604, information relating to the region information is stored in the region information DB (S606).

It is determined whether or not there is an instruction from the user to end the process of the reception program 311 (S607).

In a case where there is no instruction from the user to end the process of the reception program 311 (No in S607), the process waits according to the acquisition frequency set in S602 (S608), and then, the process returns to S603.

In a case where there is an instruction from the user to end the process of the reception program 311 (Yes in S607), the process of the reception program 311 is ended (END).

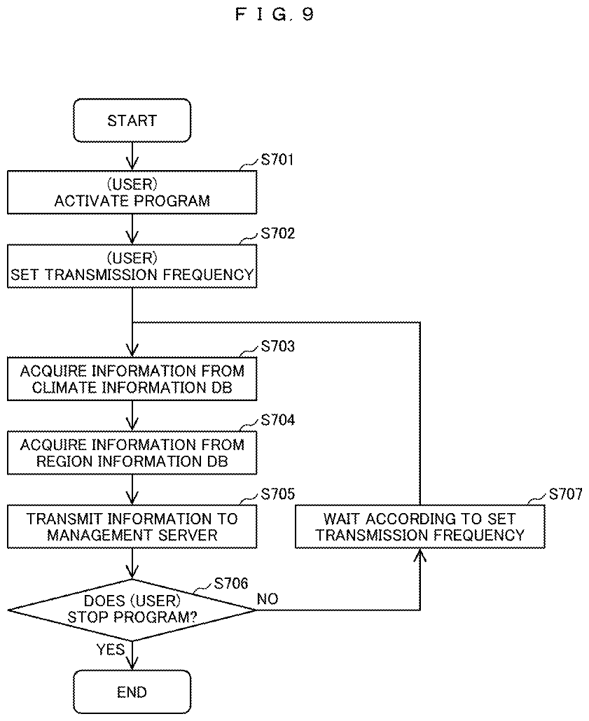

FIG. 9 is a diagram illustrating a processing flow of a transmission program 312 in the external server 30.

The transmission program 312 is activated on the basis of an instruction from the user via the input/output device (S701).

On the basis of the instruction from the user, the setting of the transmission frequency of the climate information and the region information to the management server 20 is received (S702).

The climate information that is not transmitted to the management server 20 is acquired from the climate information DB 321 recorded in the memory 301 (S703).

The region information that is not transmitted to the management server 20 is acquired from the region information DB 322 recorded in the memory 301 (S704).

The climate information and the region information acquired in S703 and S704 are transmitted to the management server 20 (S705).

It is determined whether there is an instruction from the user to end the process of the transmission program 312 (S706).

In a case where there is no instruction from the user to end the process of the transmission program 312 (No in S706), the process waits according to the acquisition frequency set in S702 (S707), and then, the process returns to S703.

In a case where there is an instruction from the user to end the process of the transmission program 312 (Yes in S706), the process of the transmission program 312 is ended (END).

According to the first embodiment, it is possible to analyze and visualize a relationship between a fault or an alarm of an equipment and a natural environment such as a season and a temperature for state-based maintenance in which maintenance is performed in accordance with a state of each equipment.

### Second Embodiment

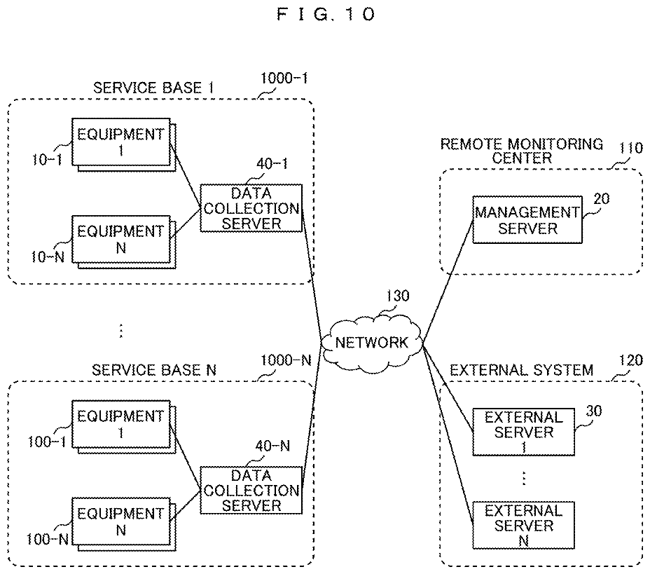

FIG. 10 is a configuration diagram illustrating a monitoring system according to a second embodiment.

The monitoring system according to the second embodiment includes a plurality of service bases such as a service base 1 1000-1 and a service base N 1000-N as locations that provide services, a remote monitoring center 110 that monitors the plurality of service bases, and an external system 120 such as an external Web site.

The plurality of service bases such as the service base 1 1000-1, the remote monitoring center 110, and the external system 120 are connected via the network 120.

Each service base such as a service base 1 1000-1 as a location that provides a service has a plurality of equipments such as an equipment 1 10-1.

The remote monitoring center 110 has a management server 20 that manages equipment registration information and equipment operation state information and manages information acquired from an external system.

The external system 120 has an external server 30 that manages external weather information, climate information, region information, and the like.

The description of the same content as those in the first embodiment will be omitted. The difference from the first embodiment is that each service base such as the service base 1 has a data collection server such as a data collection server 40-1.

Configurations of a management server 20 and an external server 30, and configurations of DBs such as the customer information DB are the same as those in the first embodiment.

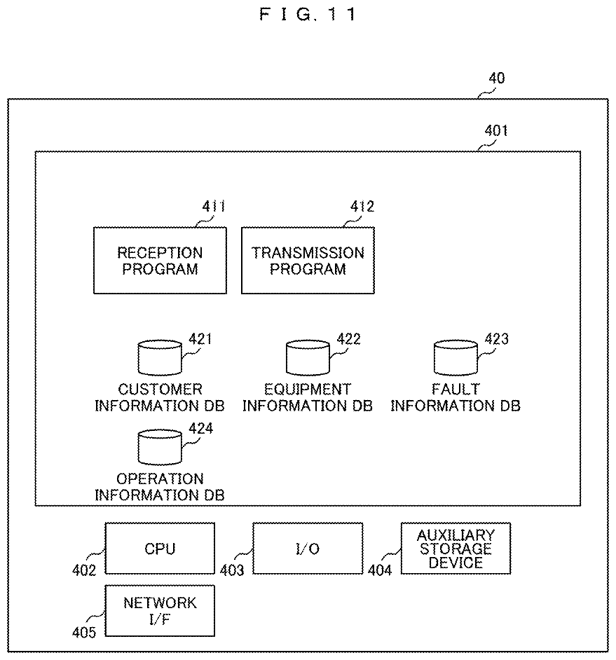

FIG. 11 is a diagram illustrating functional blocks of a data collection server 40. Similarly to the management server 20, the data collection server 40 includes a memory 401, a CPU 402, an I/O 403, an auxiliary storage device 404, and a network IF 405.

The memory 401 stores a reception program 411 and a transmission program 412. In addition, the memory 401 stores a customer information DB 421, an equipment information DB 422, a fault information DB 423, and an operation information DB 424. The content of these DBs are the same as the configurations illustrated in FIG. 4 of the first embodiment.

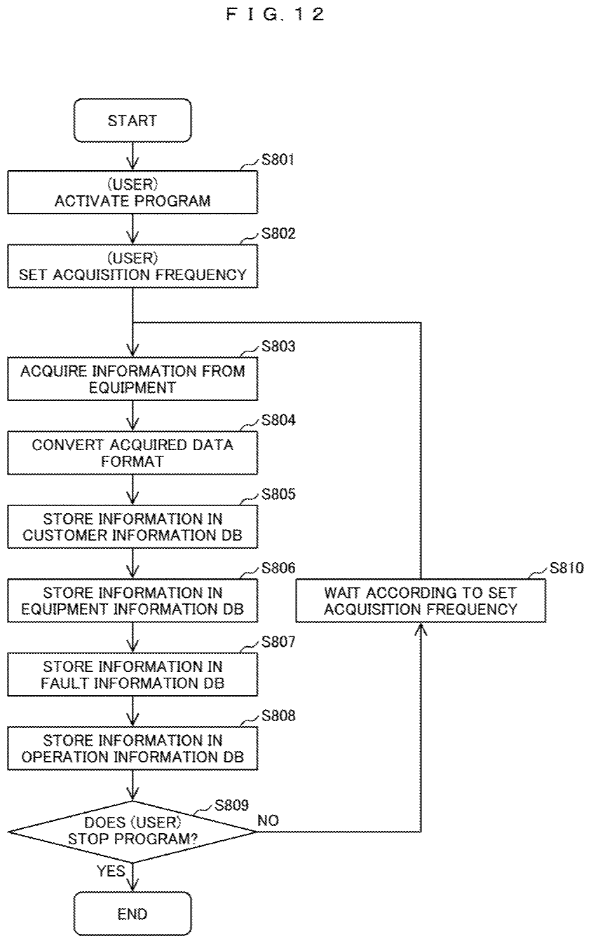

FIG. 12 is a diagram illustrating a processing flow of the reception program 411 of the data collection server 40.

The reception program 411 is activated on the basis of an instruction from the user via the input/output device (S801).

On the basis of the instruction from the user, the setting of the acquisition frequency from the equipment such as the equipment 1 10-1 arranged at the service base is received (S802).

Information is acquired from the equipment via the network 130 (S803).

The information acquired from the equipment is converted into a format in the data collection server 40 (S804).

Among the information converted in S804, information relating to the customer information is stored in the customer information DB 421 (S805).

Among the information converted in S804, information relating to the equipment information is stored in the equipment information DB 422 (S806).

Among the information converted in S804, information relating to the fault information is stored in the fault information DB 423 (S807).

Among the information converted in S804, information relating to the operation information is stored in the operation information DB 424 (S808).

It is determined whether there is an instruction from the user to end the process of the reception program 411 (S809).

In a case where there is no instruction from the user to end the process of the reception program 411 (No in S809), the process waits according to the acquisition frequency set in S802 (S810), and then, the process returns to S803.

In a case where there is an instruction from the user to end the process of the reception program 411 (Yes in S809), the process of the reception program 411 is ended (END).

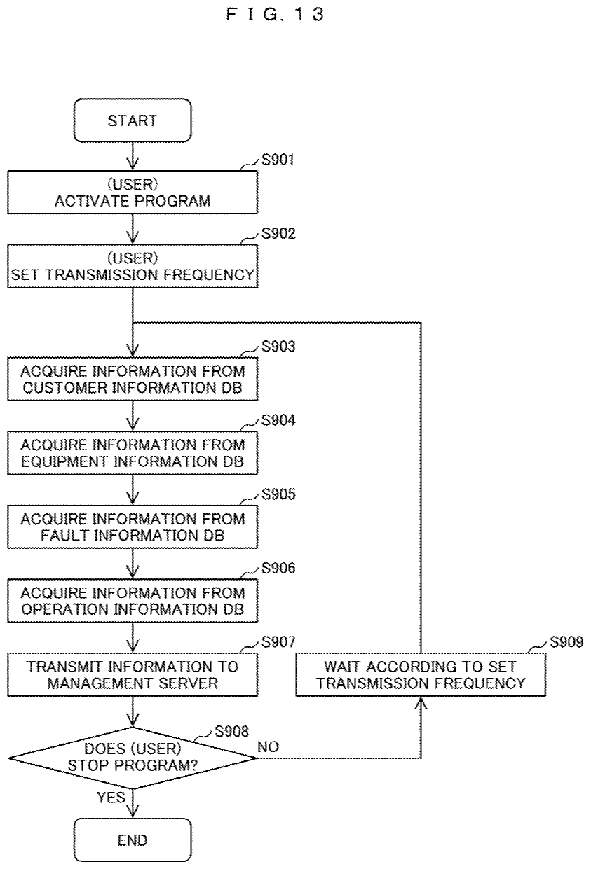

FIG. 13 is a diagram illustrating a processing flow of the transmission program 412 of the data collection server 40.

The transmission program 412 is activated on the basis of an instruction from the user via the input/output device (S901).

On the basis of an instruction from the user, the setting of the transmission frequency of the customer information, the equipment information, the fault information, and the operation information to the management server 20 is received from the data collection server 40 (S902).

The customer information that is not transmitted to the management server 20 is acquired from the customer information DB 421 recorded in the memory 401 (S903).

The equipment information that is not transmitted to the management server 20 is acquired from the equipment information DB 422 recorded in the memory 401 (S904).

The fault information that is not transmitted to the management server 20 is acquired from the fault information DB 423 recorded in the memory 401 (S905).

The operation information that is not transmitted to the management server 20 is acquired from the operation information DB 424 recorded in the memory 401 (S906).

The information acquired in steps S903, S904, S905, and S906 is transmitted to the management server 20 (S907).

It is determined whether or not there is an instruction from the user to end the process of the transmission program 412 (S908).

In a case where there is no instruction from the user to end the process of the transmission program 412 (No in S908), the process waits according to the transmission frequency set in S902 (S909), and then, the process returns to S903.

In a case where there is an instruction from the user to end the process of the transmission program 412 (Yes in S908), the process of the transmission program 412 is ended (END).

According to the second embodiment, it is possible to obtain the same effects similar to those of the first embodiment, and since the operation information from the equipment is registered by the data collection server 40, it is possible to reduce the load of the process on the management server 20.

In the above-described embodiments, an address is used as the position information. However, a configuration may be employed where the management server 20 or the data collection server 40 receives GPS position information from an equipment such as a compressor and information from an external system is specified on the basis of the position information.

In addition, in the above-described embodiments, the equipment has been described as an example of a compressor, but the equipment may be another industrial equipment such as a transformer.

In addition, the embodiment for carrying out the invention is not limited to the embodiments described above, but various modifications and equivalent configurations may be included. For example, the above-described embodiments have been described in detail in order to describe the invention in an easy-to-understand manner, and the embodiments are not necessarily limited to those having all the configurations described above. In addition, a portion of the configuration of one embodiment may be replaced with the configuration of another embodiment. In addition, a portion of the configuration of another embodiment may be added to the configuration of one embodiment.

In addition, the above-described processes by the programs and the like may be realized by designing a portion of or all of the processes by hardware, for example, an integrated circuit or may be realized by combining the processes by hardware and the processes by the programs. Information such as a program and a table can be stored in a storage device such as a memory, a hard disk drive (HDD), a solid state drive (SSD) or a recording medium such as an IC card, an SD card, or a DVD. In addition, control lines and information lines necessary for description are illustrated, and there may be control lines and information lines other than those illustrated.

What is claimed is:

1. A monitoring device, comprising:
a base information acquisition unit that acquires information relating to an equipment arranged at a base, information relating to fault, and position information of the equipment;
a natural environment information acquisition unit that acquires natural environment information; and
an analysis unit that specifies a position of the equipment in which the fault has occurred from the information acquired by the base information acquisition unit, associates the position with a region of the natural environment information, and associates the equipment in which the fault has occurred with the natural environment information.

2. The monitoring device according to claim 1, wherein the analysis unit extracts the position information relating to the equipment from customer information.

3. The monitoring device according to claim 1, wherein the base information acquisition unit acquires the position information from the equipment via a network.

4. The monitoring device according to claim 1,
wherein in a case where an instruction on a relationship between the fault and a region and season is received, the analysis unit extracts information on the region corresponding to the equipment in which the fault has occurred and the climate information on the region, and
wherein a visualization unit outputs the information on the region where the equipment in which the fault has occurred is arranged and the climate information.

5. The monitoring device according to claim 4, wherein in a case where the visualization unit receives designation of temperature as the natural environment information, the visualization unit
extracts the temperature for the equipment in which the fault has occurred,
extracts the region corresponding to the extracted temperature, and
outputs a distribution of the failed equipments to a map on the basis of the extracted information on the region.

6. The monitoring device according to claim 1, wherein the base information acquisition unit determines whether the information relating to the base is customer information, equipment information, or operation information.

7. The monitoring device according to claim 1, wherein the natural environment information acquisition unit determines whether the natural environment information acquired from an external system is climate information or region information.

8. The monitoring device according to claim 1,
wherein the base information acquisition unit records information of the equipment, fault information of the equipment, operation information indicating an operation state of the equipment, and customer information, and
wherein the natural environment information acquisition unit records climate information and region information.

9. The monitoring device according to claim 1, wherein in a case where the analysis unit receives an instruction to analyze an occurrence rate of the fault or alarm, the analysis unit extracts equipment information, customer information, and fault information on the basis of an identification number identifying the equipment for which the occurrence rate is to be obtained.

10. The monitoring device according to claim 1, wherein in a case where the visualization unit receives an instruction to visualize an occurrence time zone of the fault or the alarm, the visualization unit extracts the occurrence time zone on the basis of fault information acquired from the analysis unit.

11. A monitoring system, comprising:
a first equipment provided at a first base;
a second equipment provided at a second base;
the monitoring device according to claim 1, the monitoring device being connected to the first equipment and the second equipment via a network; and
an external device that has an acquisition unit that acquires climate information and region information from an external system and a providing unit that provides the climate information and the region information to the monitoring device.

12. The monitoring system according to claim 11, wherein the external device includes a first format conversion processing unit that converts a format of the external system.

13. A monitoring system comprising:
a first equipment provided at a first base;
a first data collection device provided at the first base;
a second equipment provided at a second base;
a second data collection device provided at the second base;
the monitoring device according to claim 1, the monitoring device being connected to the first equipment and the second equipment via a network; and
an external server having a first acquisition unit that acquires climate information and region information from an external system, and a first providing unit that provides the climate information and the region information to the monitoring device,
wherein each of the first data collection device and the second data collection device includes:
a second acquisition unit that repeatedly acquires customer information, equipment information, fault information, and operation information from the first equipment or the second equipment; and
a second providing unit that repeatedly provides the acquired information to the monitoring device.

14. The monitoring system according to claim 13, wherein each of the first data collection device and the second data collection device includes a second format conversion processing unit that format-converts data acquired from the equipment.
